(19) United States
(12) Patent Application Publication
(10) Pub. No.: US 2026/0257659 A1
(43) Pub. Date: Sep. 3, 2026

(54) ELECTROMECHANICAL BRAKING DEVICE FOR A MOTOR VEHICLE, WITH A CIRCUIT ARRANGEMENT FOR OPERATING THE ELECTRIC MOTORS OF THE BRAKING DEVICE

(71) Applicants: thyssenkrupp Presta AG, Eschen (LI); thyssenkrupp AG, Essen (DE)

(72) Inventors: Mark MULLER, Budapest (HU); Barna SZIMANDL, Gams (CH); Zoltan Szabolcs ERDELYI, Budapest (HU)

(73) Assignees: thyssenkrupp Presta AG, Eschen (LI); thyssenkrupp AG, Essen (DE)

(21) Appl. No.: 19/165,094

(22) PCT Filed: Oct. 24, 2023
(86) PCT No.: PCT/EP2023/079619

§ 371 Date: Sep. 12, 2025

(30) Foreign Application Priority Data
Mar. 15, 2023 (BE) BE 2023/5185

(51) Int. Cl. B60T 13/74; B60T 17/22; F16D 55/226; F16D 65/18; F16D 121/24; H02K 7/102

(52) U.S. Cl. CPC B60T 13/746; B60T 17/22; F16D 65/18; H02K 7/102; B60T 2270/402; F16D 55/226; F16D 2121/24

(57) ABSTRACT

An electromechanical braking device for a motor vehicle comprises a positioning device and a brake part connected thereto, which is displaceable by the positioning device along an axis and can be brought into braking engagement with a counter brake part, wherein the positioning device has a first positioning drive and a second positioning drive and the positioning device, to implement a displacement movement, comprises a first three-phase electric motor and a second three-phase electric motor having a circuit assembly for operating the electric motors, wherein the circuit assembly comprises a first control path having a first power module for controlling the first electric motor and a second control path having a second power module for controlling the second electric motor, and wherein the circuit assembly comprises a first computing unit and a first driver stage, wherein the first computing unit is designed to determine an electric motor setpoint specification on the basis of acquired parameters and to actuate a power module to influence the motor currents via a driver stage, so that the electric motor setpoint specification is implemented.

The invention relates to an electromechanical braking device for a motor vehicle, wherein the braking device comprises a positioning device and a brake part connected thereto, which is displaceable by the positioning device along an axis and can be brought into braking engagement with a counter brake part. The positioning device has a first positioning drive and a second positioning drive here and comprises a first three-phase electric motor for implementing a displacement movement and a second three-phase electric motor having a circuit assembly for operating the electric motors.

Such a braking device of a motor vehicle is designed as a friction brake, in which a brake part, which is supported on the chassis and is stationary relative to the rotation of the wheel to be braked, can be brought into braking engagement with a counter brake part, which rotates with the wheel, by means of a positioning device. In braking engagement, friction contact is created between brake part and counter brake part, wherein the braking torque generated by friction is greater the higher the displacement force exerted by the positioning device in the displacement direction is.

Disk brakes are a widespread structural form, in which the counter brake part is formed by a brake disk rotating with the wheel, which is axially encompassed on both sides by a brake caliper. A brake part, generally a brake lining, can be displaced in an axial displacement direction and thus brought into friction contact with an axial side of the brake disk by at least one positioning drive, which is axially supported on the brake caliper and is preferably linear, wherein the brake disk is clamped in a friction-locked manner in the braking engagement between the displaced brake part and a further brake part supported axially opposite on the brake caliper.

One condition for perfect function and very precise response of the brake is that a defined distance, the so-called air gap, is provided in the unoperated state between the brake part and the counter brake part in the displacement direction. Upon the actuation of the brake, the brake part is moved perpendicularly to the air gap by the positioning device toward the counter brake part until the air gap is overcome and the friction contact is achieved, so that the braking engagement is generated.

For a reproducible and very precise response of the brake in driving operation, it is crucial that the air gap has a defined gap width measured in the axial displacement direction in the unoperated state. The gap width can increase in the course of operation, for example due to wear of the brake lining, and accordingly has to be readjusted. To adjust the air gap, it is known from DE 10 2017 123 266 A1 that the positioning device has two positioning drives arranged in series in the displacement direction. Each of the positioning drives has a drive-side drive element and an output-side output element, which is linearly displaceable relative thereto in the axial displacement direction. To implement a displacement movement, each drive element has a drive wheel, which is drivable to rotate around its axis by an electrical actuating motor. The rotation of the drive wheel is converted in the positioning drive in each case into a relative displacement movement or a positioning stroke of the output element relative to the drive element in the axial displacement direction.

A positioning drive forms a stroke or displacement unit axially active in the displacement direction in each case. For example, a positioning drive can have a spindle drive, in which the drive element has a spindle nut, and the output element has a threaded spindle engaging therein, or vice versa. Other structural forms of positioning drives can also be used, which can comprise, for example, ramp bearings, cam disks or curve disks, swivel pin assemblies, or the like, and also convert a rotation of the drive element into a linear displacement of the output element.

Because the drive element of the second positioning drive is coupled with the output element of the first positioning drive, and the brake element is attached to the output element of the second positioning drive, by operating the first positioning drive, the brake element can be linearly displaced together with the second positioning drive to generate the braking engagement. The air gap can be adjusted by a displacement of the second positioning drive independently of the operation of the first positioning drive. The first positioning drive can therefore be operated continuously in the optimum working range.

A further advantage of the two coupled positioning drives is that a redundant design is possible. Accordingly, in principle, the braking engagement can also be generated, for example, by the second positioning drive, which in normal operation is only used to adjust the air gap. To increase the fault tolerance, it is also important here that the electric motors can be actuated reliably.

Against this background, it is an object of the present invention to provide an improved electromechanical braking device, in particular having a circuit assembly for operating the electric motors with a high level of reliability.

An electromechanical braking device as claimed in claim 1 is proposed to achieve this object. Further advantageous designs of the invention are described in the dependent claims and the description and shown in the figures.

The proposed solution provides an electromechanical braking device for a motor vehicle comprising a positioning device and a brake part connected thereto, wherein the brake part is displaceable by the positioning device along an axis and can be brought into braking engagement with a counter brake part, and wherein the positioning device has a first positioning drive and a second positioning drive and the positioning device comprises a first three-phase electric motor and a second three-phase electric motor having a circuit assembly for operating the electric motors to implement a displacement movement. It is provided according to the invention that the circuit assembly comprises a first control path having a first power module for controlling the first electric motor and a second control path having a second power module for controlling the second electric motor, and that the circuit assembly comprises a first computing unit and a first driver stage. The first computing unit is designed here to determine an electric motor setpoint specification on the basis of acquired parameters and to actuate a power module to influence the motor current via a driver stage, so that the electric motor setpoint specification is implemented. The acquired parameters in particular comprise here a braking specification, which can be specified in particular by a driver or a driver assistance system, and a current velocity of the motor vehicle. The power modules advantageously each comprise an inverter here, which preferably in each case comprises a bridge circuit made of MOSFETs (MOSFET: metal oxide semiconductor field-effect transistor) for the control of the respective electric motor. Furthermore, the respective power module can advantageously comprise a phase separation unit, which preferably has a phase relay for each phase of the respective electric motor. Furthermore, the respective power module advantageously comprises a PWM controller (PWM: pulse width modulation). Using such a circuit assembly, the electric motors can advantageously be operated with a high level of reliability and a high level of fault tolerance.

One particularly advantageous design of the braking device provides that the second positioning drive is coupled in series with the first positioning drive, wherein the first positioning drive has a first drive wheel, which is drivable to rotate, and the second positioning drive has a second drive wheel, which is drivable to rotate and is coaxial to the first drive wheel, wherein a coupling device is arranged between the first drive wheel and the second drive wheel, and wherein the coupling device is designed as a friction clutch having a friction element which is connectable in a friction-locked manner to a counter friction element in the coupling engagement, wherein the first electric motor enables an operation of the first positioning drive and the second electric motor enables an operation of the second positioning drive. The first and the second drive wheel are sometimes also designated together hereafter as the two drive wheels or in short as the drive wheels. The drive wheels can be formed as a gear wheel, in particular as a spur wheel, or as a belt wheel or toothed belt wheel or worm wheel, so that advantageously a transmission wheel is provided, via which a drive torque can be coupled from the respective electric motor into the positioning drive.

A friction clutch is preferably implemented between the drive wheels. This comprises a friction element, which is connected in a torque-locked manner to the one of the drive wheels, and a counter friction element corresponding thereto, which is connected in a torque-locked manner with the respective other drive wheel. The friction element can be brought into friction-locked coupling engagement with the counter friction element in any arbitrary relative angle position. A solely friction-locked coupling is preferably implemented here. The relative position of the drive wheels in relation to one another can thus advantageously be specified continuously. A uniform continuous displacement of the second positioning drive relative to the first positioning drive is accordingly enabled, and a continuous adjustment of the air gap can take place. This is particularly advantageous with regard to uniform tracking of the optimum operating point of the braking device to the continuous wear of the brake part in operation, i.e. the continuous wear of the brake lining. A continuously improved response behavior of the braking device can thus be implemented, and thus increased operational safety and higher operating comfort. Furthermore, advantageously, essentially no axial relative movement between the coupling elements that are in coupling engagement is required for operating and releasing the coupling device, for example between the drive wheels or the detent elements, which necessarily have to be movable toward one another to generate and release the lockable form fit. In contrast, solely the friction lock between the friction element and the counter friction element can simply be specified by the applied axial operating force, wherein friction element and counter friction element do not have to be relatively moved toward one another axially. A simpler and more reliable constructive design of the coupling device is thus enabled.

According to a further advantageous design, the circuit assembly is designed to control the first electric motor and the second electric motor using the first computing unit and the first driver stage. In particular, one design provides that the first computing unit is designed to determine a first setpoint specification for the first electric motor and a second setpoint specification for the second electric motor on the basis of the received parameters and to actuate both the first power module assigned to the first electric motor and the second power module assigned to the second electric motor via the first driver stage to influence the motor currents so that the first setpoint specification is implemented by the first electric motor and the second setpoint specification is implemented by the second electric motor. In this design, in the event of a failure of one of the electric motors, the other electric motor can advantageously still be actuated to generate a braking engagement.

A further advantageous design provides that the circuit assembly additionally comprises a second driver stage, wherein the first driver stage is advantageously assigned to the first control path, and the second driver stage is advantageously assigned to the second control path. The circuit assembly is preferably configured here so that the first computing unit is designed to determine a first setpoint specification for the first electric motor and a second setpoint specification for the second electric motor on the basis of the received parameters and to actuate the first power module via the first driver stage and the second power module via the second driver stage to influence the motor currents so that the first setpoint specification is implemented by the first electric motor and the second setpoint specification is implemented by the second electric motor. An interconnection of the first driver stage and the second driver stage is advantageously provided here such that in the event of a failure of the second driver stage, an actuation of the first power module and an actuation of the second power module via the first driver stage is enabled. Furthermore, an interconnection of the first driver stage and the second driver stage is advantageously provided such that in the event of a failure of the first driver stage, an actuation of the first power module and an actuation of the second power module via the second driver stage is enabled. The driver stages are insofar redundantly provided and thus advantageously further increase the fault tolerance. A monitoring unit assigned to the circuit assembly is preferably designed here to detect a functional impairment of the first driver stage and/or the second driver stage. In this design, in the event of a failure of one of the driver stages, the electric motors can advantageously still be actuated via the still functional driver stage to generate a braking engagement.

It is provided as a further advantageous design that the circuit assembly comprises a second driver stage and a second computing unit, wherein the first driver stage and the first computing unit are advantageously assigned to the first control path, and the second driver stage and the second computing unit are advantageously assigned to the second control path. The second computing unit, in particular also the first computing unit, is advantageously designed to determine an electric motor setpoint specification on the basis of acquired parameters and to actuate a power module to influence the motor currents via a driver stage, so that the electric motor setpoint specification is implemented. In particular, it is provided that in trouble-free operation, the first computing unit determines a first electric motor setpoint specification for the first electric motor on the basis of acquired parameters and actuates the first power module via the first driver stage to influence the motor currents of the first electric motor to implement the first electric motor setpoint specification. Furthermore, it is provided in particular in trouble-free operation that the second computing unit determines a second electric motor setpoint specification for the second electric motor on the basis of acquired parameters and actuates the second power module via the second driver stage to influence the motor currents of the second electric motor to implement the second electric motor setpoint specification. For the case of a functional disturbance at the first computing unit, the second computing unit is advantageously also designed, however, to determine a first electric motor setpoint specification for the first electric motor and to actuate the first electric motor accordingly via the first control path. Advantageously, for the case of a functional disturbance at the second computing unit, the first computing unit is accordingly also designed to determine a second electric motor setpoint specification for the second electric motor and to actuate the second electric motor accordingly via the second control path. In this way, two control paths usable independently of one another are advantageously provided, by which it is advantageously furthermore ensured that in the event of a functional impairment in one of the control paths, the associated electric motor can still be operated via the other control path and thus a braking engagement can be implemented in spite of a functional impairment. The first control path and the second control path are preferably designed redundantly to one another. In particular, it can also be provided here that one of the computing units, in particular the first computing unit, is defined as the master computing unit, which in normal operation determines the first electric motor setpoint specifications and the second electric motor setpoint specifications and actuates the first electric motor via the first control path and the second electric motor via the second control path, wherein the second computing unit, which can in particular be designed as lower performance than the first computing unit in this case, checks the setpoint specifications determined by the first computing unit for plausibility. Advantageously, if a functional impairment has been detected with regard to the first computing unit, the setpoint specifications are determined by the second computing unit and the second computing unit takes over the actuation of the first and the second electric motor via the respective control path.

In particular, in the design in which the circuit assembly comprises a first computing unit and a first driver stage in the first control path and comprises a second computing unit and a second driver stage in the second control path, the first computing unit is designed to actuate the first power module via the first driver stage to influence the motor currents of the first electric motor and the second computing unit is designed to actuate the second power module via the second driver stage to influence the motor currents of the second electric motor. Furthermore, the first computing unit is advantageously furthermore designed here to actuate the first power module via the first driver stage to influence the motor currents of the first electric motor and to actuate the second power module via the second driver stage to influence the motor currents of the second electric motor. Furthermore, the second computing unit is advantageously furthermore designed here to actuate the second power module via the second driver stage to influence the motor currents of the second electric motor and to actuate the first power module via the first driver stage to influence the motor currents of the first electric motor. A failure of the first computing unit can therefore advantageously be compensated for by the second computing unit and vice versa.

According to a further advantageous design, a first rotor position sensor is assigned to the first electric motor and a second rotor position sensor is assigned to the second electric motor. The first rotor position sensor is advantageously connected here to the first computing unit and/or the second computing unit to transmit rotor position signals and the second rotor position sensor is advantageously connected to the first computing unit and/or the second computing unit to transmit rotor position signals. The rotor position signals are advantageously further parameters which the first computing unit acquires or the first computing unit and the second computing unit acquire in order to determine an electric motor setpoint specification. In particular, it is provided that the first rotor position sensor is connected to the first computing unit to transmit rotor position signals and the first computing unit is designed to forward these rotor position signals to the second computing unit. Furthermore, the second rotor position sensor is advantageously connected to the second computing unit to transmit rotor position signals and the second computing unit is designed to forward these rotor position signals to the first computing unit.

Furthermore, one advantageous design of the braking device provides that the first control path comprises a first connection element for connection to a voltage source of a motor vehicle as an energy source and/or the second control path comprises a second connection element for connection to a voltage source of a motor vehicle as an energy source. In particular a connection to an energy source of a motor vehicle, in particular to a battery of the motor vehicle, can take place via these connection elements. In this case, the first control path is preferably supplied via the first connection element with energy from the energy source of the motor vehicle and the second control path is supplied with energy from the energy source of the motor vehicle via the second connection element. A fault tolerance is advantageously further improved by this redundancy. An EMI filter (EMI: electromagnetic interference) is advantageously assigned to the first connection element and/or an EMI filter is assigned to the second connection element.

According to a further advantageous design, the first control path comprises a first interface for connection to a communication channel, in particular a CAN bus, of a motor vehicle and/or the second control path comprises a second interface for connection to a communication channel, in particular a CAN bus, of a motor vehicle. Vehicle parameters can be provided to the first computing unit and/or the second computing unit via this first interface and/or this second interface, in particular a braking specification and/or a current vehicle velocity, which are taken into consideration in the determination of the electric motor setpoint specification. A fault tolerance is advantageously further improved by this redundancy.

Furthermore, the first control path advantageously comprises a third interface for connection to a wheel speed sensor and/or the second control path comprises a third interface for connection to a wheel speed sensor. Sensor signals of the wheel speed sensor can advantageously be transmitted via these interfaces as further parameters to the first computing unit and/or to the second computing unit.

According to a further advantageous design, the first control path comprises a transceiver unit and/or the second control path comprises a transceiver unit. The transceiver unit is advantageously designed here for a data exchange between the respective computing unit and the motor vehicle, in particular via the first interface and/or the second interface.

With respect to a design of the braking device, in which a coupling device designed as a friction clutch is provided between a first drive wheel and a second drive wheel, the friction clutch preferably has a coupling torque specifiable in a defined manner. The coupling torque specifies the maximum differential torque which can be transmitted in a friction-locked manner between friction element and counter friction element by the friction lock in the coupling engagement. If the coupling torque is exceeded, the coupling device slips through, so that the two drive wheels are rotated relative to one another. One advantage here is that the friction clutch according to the invention slips through continuously in a sliding manner, so that an improved uniform adjustment of the air gap is enabled. In addition, no axial evasion movements of detent elements have to be taken into consideration in design and absorbed.

It is advantageous that the friction element and the counter friction element of the coupling device are arranged coaxially. The coaxial arrangement advantageously corresponds here with the coaxial arrangement of the drive wheels. The friction element and the counter friction element can be arranged in a structurally simple manner and in a compact structural form in the area of the end faces of the drive wheels directed axially toward one another. No movable parts are required due to the above-described generation of the pure friction lock of the clutch.

In one advantageous embodiment, it can be provided that the friction element and the counter friction element are formed conical. The friction element can have a cone section, which tapers at least in some sections in the axial displacement direction here, having a conical friction surface, which can be designed as an outer cone or inner cone, and which engages with a corresponding cone section on the counter friction element, which is accordingly designed inversely as an inner cone or outer cone and has a conical counter friction surface. To generate the coupling engagement, the outer cone plunges into the inner cone, wherein the conical friction and counter friction surfaces are loaded in a friction-locked manner against one another by an axial operating force of the clutch. One advantage here is that a force conversion of the operating force of the clutch acting axially into the normal force acting between the conical friction surfaces in friction contact can be carried out by the cone. A relatively small axial operating force can thus be converted into a larger normal force in friction contact by a flatter slope, by which a high coupling torque is already implementable by a relatively small axial operating force of the clutch.

Alternatively or additionally to the above-mentioned embodiment, it can be provided that the friction element and the counter friction element are formed planar. The friction surfaces corresponding with one another are preferably formed here at least in some sections as planar axial surfaces, similarly to a disk clutch. A space-saving arrangement is enabled, in particular if only a relatively small coupling torque is to be implemented.

It can be provided in particular that the friction element and the counter friction element are pre-tensioned against one another. The friction element and the counter friction element are preferably pre-tensioned against one another in an elastic or springy manner. The friction and counter friction surfaces are pressed against one another with a specified axial pre-tensioning force in the friction lock here. An elastic pre-tensioning element, in particular a spring element or the like, can preferably be provided to generate the pre-tensioning force. The coupling torque of the friction clutch is determined by the operating force acting perpendicularly to the friction contact, thus the force applied axially between friction element and counter friction element, wherein the coupling torque is greater the greater the pre-tensioning force is. This opens up the advantageous possibility of specifying the coupling torque simply by the pre-tensioning force exerted by the pre-tensioning element. For example, in the case of a spring element which is compression-elastic in the axial direction, in particular a compression spring, the exerted pre-tensioning force can be specified and adapted simply by the spring constant and the compression of the spring.

The above-mentioned embodiment can advantageously be implemented in that the friction element and/or the counter friction element is axially movable and is supported via an axially active spring element against the first drive wheel or the second drive wheel. The friction element or the counter friction element are connected in a torque-locked and axially movable manner here to the one drive wheel, in particular via radially protruding carriers generating a form fit active in the circumferential direction. The spring element axially braced between the friction element or the counter friction element and the one drive wheel, which is preferably designed as an axially active compression spring, ensures that the friction element or counter friction element is axially pre-tensioned against the corresponding counter friction element or friction element axially supported on the other drive wheel, i.e. is axially pressed in friction contact against it. The corresponding counter friction element or friction element is connected in a rotationally-locked manner to the respective other drive wheel. It is also possible that alternatively or additionally the counter friction element is supported via a spring element on one of the drive wheels. One advantage of this arrangement is that the friction clutch according to the invention can be incorporated in a structurally simple and space-saving manner between the drive wheels.

In one advantageous refinement, it is possible that the friction element and/or the counter friction element is arranged in the first drive wheel or the second drive wheel. It is thus possible to make the one drive wheel essentially drum-shaped, so that the friction element or counter friction element can be arranged in an interior enclosed by the circumferential gear wheel or gear rim. A compact structural form protected against external influences is thus enabled. The drive wheel of the first positioning drive can thus have a conical friction element, for example, which engages axially in a counter friction element designed as an inner cone, which is arranged at least partially inside the second drive wheel.

A particularly compact structural form can be implemented—in particular in the last-mentioned embodiment—in that the drive wheels are arranged within the axial extension of the positioning drives, thus are not attached axially protruding on one side.

It is preferred that the friction element and/or the counter friction element has/have a friction lining. The friction element and counter friction element preferably have a metallic main body, in particular made of steel. To avoid metal-on-metal contact, a coating or a lining can preferably be applied to generate a friction pairing with a defined frictional force, in particular made of sintered, metal, and/or ceramic frictional materials, composite materials, or the like. A defined reproducible coupling torque can thus be ensured.

Furthermore, a positioning drive advantageously has a spindle drive, which is advantageously driven by one of the electric motors. In the spindle drive, a threaded spindle engages in a manner known per se in a spindle nut and a relatively rotating drive engages via a drive wheel connected to the threaded spindle or the spindle nut. According to one design variant, the spindle nut forms the drive-side drive element of the positioning drive, and the threaded spindle forms the output-side output element linearly displaceable relative thereto. A further design variant is accordingly designed inversely.

A further design provides that a positioning drive has a ball ramp arrangement, wedge disk arrangement, or a swivel pin arrangement. In a ball ramp arrangement, also referred to as a ramp bearing, the drive element and output element preferably have curve disks having runways or ramps inclined in relation to the axis, between which balls rollable in the circumferential direction are arranged. A relative rotation has the result here, due to the balls rolling on the ramps, that the output element is axially moved relative to the drive element. In a swivel pin arrangement known per se, swivel pins are arranged between drive element and output element and are each supported in the circumferential direction such that upon a relative rotation, they are inclined more strongly or weakly in relation to the axis depending on the rotational direction, by which the distance between drive element and output element is also adjustable.

In the positioning device, according to a further design, two positioning drives acting equivalently are advantageously combined with one another as the first and second positioning drives, in particular two spindle drives. According to an advantageous design variant, however, combining two different structural forms with one another is also provided, in particular a ball ramp arrangement as the first positioning drive and a spindle drive as the second positioning drive for adjusting the air gap. The respective characteristic properties of each structural form can be optimally utilized here. In particular, a nonlinear displacement characteristic can be implemented using a ball ramp arrangement with low expenditure, and/or self-inhibiting properties at least in some sections, and/or a defined dead center position or stretched position, which enables a defined displacement travel. The implementation of the mentioned positive properties can at least partially require a precise specification of the air gap, which can be implemented by means of the proposed friction clutch.

To operate an electromechanical braking device in a motor vehicle, in particular a braking device designed according to the invention, it is provided that a braking specification is acquired and a setpoint specification for the first electric motor and/or the second electric motor is determined in consideration of at least one further parameter of the motor vehicle and the first electric motor and/or the second electric motor is actuated via a control path having a driver stage and a power module for implementing the determined setpoint specification.

In particular, the braking device provided for the method for operating the braking device comprises a positioning device and a brake part connected thereto, which is displaceable by the positioning device along an axis and can be brought into braking engagement with a counter brake part, wherein the positioning device has a first positioning drive and a second positioning drive and the positioning device comprises a first three-phase electric motor and a second three-phase electric motor having a circuit assembly for operating the electric motors to implement a displacement movement, wherein the circuit assembly comprises a first control path having a first power module for controlling the first electric motor and a second control path having a second power module for controlling the second electric motor, and wherein the circuit assembly comprises a first computing unit and a first driver stage, wherein the first computing unit is designed to determine an electric motor setpoint specification on the basis of acquired parameters and to actuate a power module to influence the motor currents via a driver stage, so that the electric motor setpoint specification is implemented.

In a method for operating an electromechanical braking device, which has a positioning device comprising a first positioning drive and a positioning drive coupled in series therewith, and which acts on a brake part, which can be brought into braking engagement with a counter brake part in the direction of an axis, wherein the first positioning drive has a first drive wheel drivable to rotate, to which a first drive torque can be applied for operation, in particular by means of the first electric motor, and the second positioning drive has a second drive wheel, coaxial to the first drive wheel, drivable to rotate, to which a second drive torque can be applied for operation, in particular by means of the second electric motor, wherein a coupling device is arranged between the first drive wheel and the second drive wheel, it is advantageously provided that the coupling device is designed as a friction clutch and has a specifiable coupling torque, upon the exceeding of which the first drive wheel slips through in a sliding manner relative to the second drive wheel, wherein the first drive wheel and the second drive wheel are driven synchronously to operate the first positioning drive, so that the second positioning drive remains unoperated, and the second drive wheel is driven to operate the second positioning drive, and the first drive wheel is made stationary relative thereto, so that the friction clutch slips through and the first positioning drive remains unoperated. The features mentioned above in conjunction with the braking device according to the invention can be used individually and in combination to implement the proposed method. To displace the first positioning drive, an actuating torque is coupled into the first drive wheel by means of the first three-phase electric motor, in particular a first electrical actuating motor. Accordingly, the second positioning drive is driven by the second three-phase electric motor, in particular a second electrical actuating motor.

In normal braking operation, the first and the second drive wheel are rotated synchronously. This can take place, on the one hand, in that the first and the second drive wheel are driven by the first and second electric motor using synchronized drive torques. On the other hand, the second drive wheel can be carried along synchronously by the coupling device upon the drive of the first drive wheel, as long as the transmitted drive torque remains below the coupling torque. In this operating mode, the second positioning drive remains unoperated, and idly rotates as a whole together with the brake element.

According to a further advantageous design, in a method for operating a service brake, the coupling device can slip through continuously and uniformly in a sliding manner upon exceeding of the coupling torque to adjust the air gap. This is implemented in particular in that the drive wheel of the first positioning drive is fixed, in particular by a brake or a corresponding actuation of the first electric motor, while a second drive torque, which is greater than the coupling torque, is applied to the second drive wheel by the second electric motor. The second drive wheel is thus rotated relative to the first drive wheel, and the air gap can be adjusted continuously and precisely by operating the second positioning drive, so that a continuous progressive wear of the brake element or the brake lining can be compensated for optimally.

A further advantageous design of the method provides that the first drive wheel and the second drive wheel are coupled in a torque-locked manner by the friction clutch to generate a synchronous drive. A synchronous drive of the two drive wheels by the electric motors is not required here. Possible torque differences can be balanced out within specified tolerances.

It can advantageously be provided that a higher coupling torque is specified upon the operation of the first positioning drive than upon the operation of the second positioning drive. The first positioning drive is operated by synchronous drive of the first and the second drive wheel. The friction element and the counter friction element are pre-tensioned against one another by the spring force of the spring element, and additionally the displacement force of the first positioning drive acts opposite to the spring force. A relatively high coupling torque is thus implemented. In contrast, if only the second drive wheel is rotated to adjust the air gap, the spring force thus acts alone, so that a lower coupling torque is set. The adjustment of the air gap is thus facilitated.

Further advantageous characteristics, features, and design details of the invention are shown in conjunction with the exemplary embodiments shown in the figures (hereinafter in particular Fig.: Figure). In the figures:

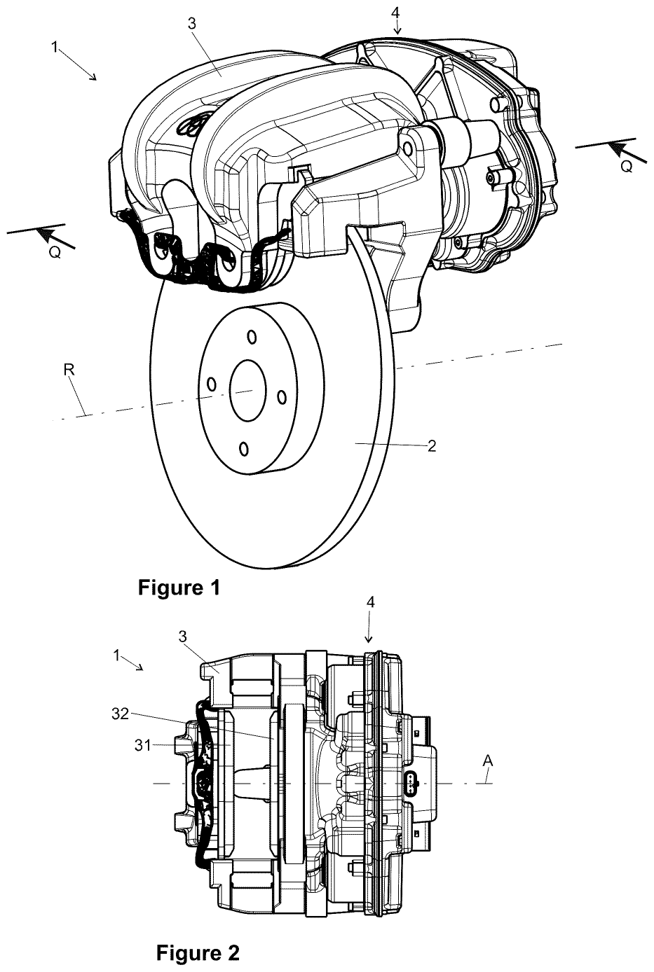

FIG. 1 shows an exemplary embodiment of a braking device designed according to the invention in a schematic perspective view;

FIG. 2 shows a lateral view of the braking device according to FIG. 1;

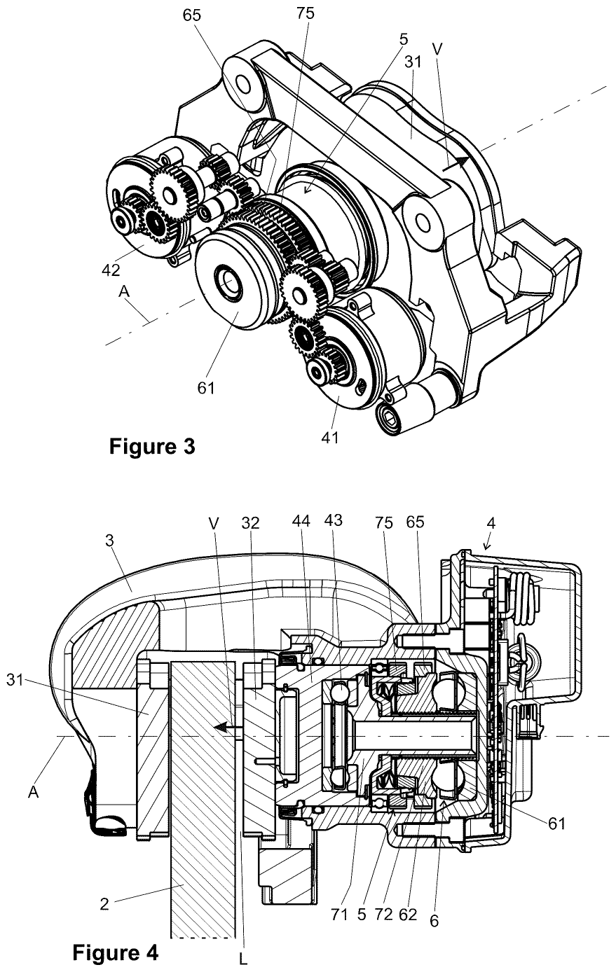

FIG. 3 shows an exemplary embodiment of a positioning device designed according to the invention of the braking device from FIG. 1 isolated in a schematic perspective view;

FIG. 4 shows a section Q-Q through the braking device from FIG. 1;

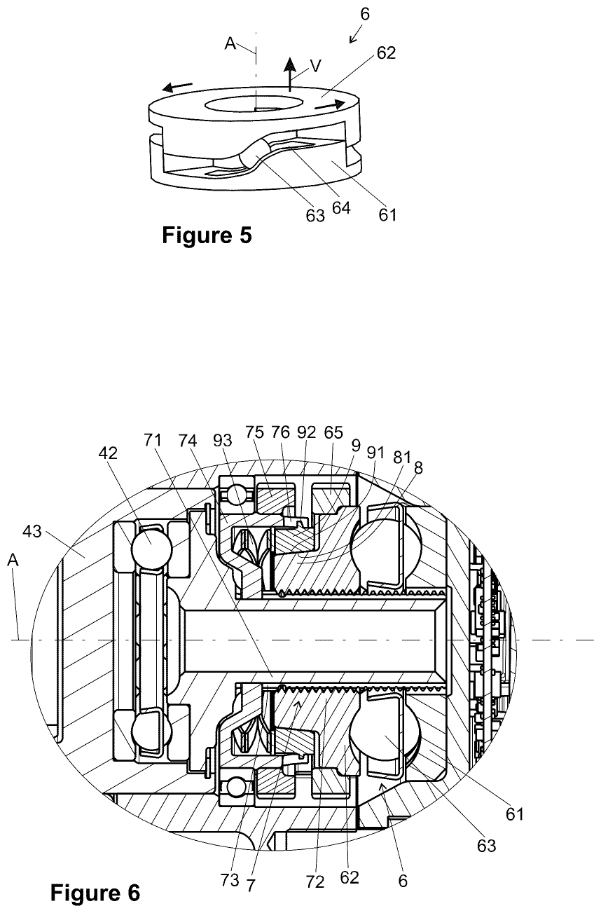

FIG. 5 shows the first positioning drive of the braking device from FIG. 1 isolated in a schematic perspective view;

FIG. 6 shows an enlarged detail view of the positioning device from FIG. 4; and

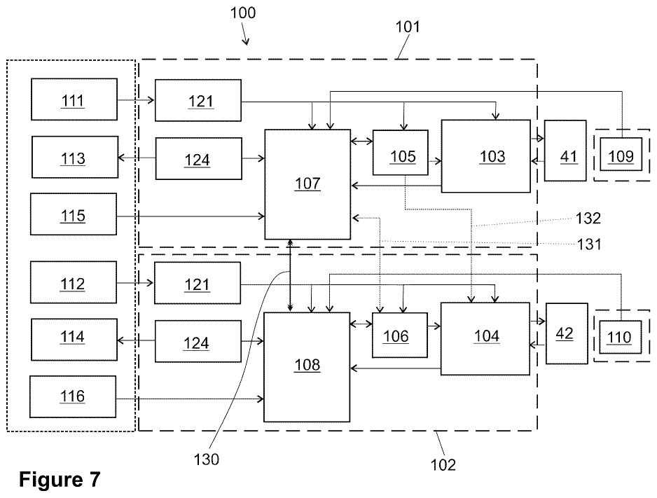

FIG. 7 shows an exemplary embodiment of a circuit assembly designed according to the invention for operating the electric motors of a braking device designed according to the invention.

In the various figures, identical parts are generally provided with identical reference signs and are therefore sometimes each also only explained in conjunction with one of the figures.

First, in particular an advantageous constructive design of an exemplary embodiment for a braking device 1 designed according to the invention will be described with reference to FIGS. 1 to 6, wherein an advantageous design of a circuit assembly 100 for operating the first electric motor 41 and the second electric motor 42 of the braking device 1 in a motor vehicle will be described with reference to FIG. 7.

For example, in a two-wheeled vehicle, which can be designed as a motorcycle, one braking device 1 can be provided per wheel. In a four-wheeled vehicle, which can be designed, for example, as a passenger vehicle, trucks, or bus, one braking device 1 can likewise be provided per wheel. In this case, each of the braking devices 1 preferably has a circuit assembly 100 in each case, that is to say each braking device 1 has its own circuit assembly 100, which is formed separately and independently in each case from the circuit assemblies 100 of the other braking devices 1. However, it is provided in particular that the circuit assemblies 100 of the braking devices 1 can exchange data with one another, in particular with respect to a wheel speed of the wheel assigned to the respective braking device 1 and/or a functional impairment of one of the braking devices 1.

FIG. 1 shows the braking device 1 as a whole, wherein the braking device 1 is designed as a disk brake. The braking device 1 in this exemplary embodiment comprises a brake disk 2, which forms a counter brake part and, when it is used as intended in a motor vehicle, is connected to a vehicle wheel (not shown here) rotatable around a wheel axis R. A brake caliper 3 encompasses the two axial end faces of the brake disk 2. The brake disk 2 is designed in this exemplary embodiment as an unventilated brake disk made of solid material. According to a design variant which is not shown here, it can in particular also be designed as an internally-ventilated brake disk.

An electrical brake actuator 4 is attached to the brake caliper 3 of the braking device 1, which actuator is shown in a separate isolated schematic perspective view in FIG. 3 and is explained in detail with reference to FIGS. 4 to 7. The brake actuator 4 comprises a positioning device 5, which extends axially in the direction of an axis A which is parallel to the wheel axis R and specifies the displacement direction V of the positioning device 5.

As can be seen in the sectional illustration of FIG. 4 along the axis A, the brake disk 2 is axially arranged between two brake linings 31 and 32. The one brake lining 31 is fixedly supported on the brake caliper 3 on the side facing away from the brake actuator 4. The other brake lining 32, which forms a brake part in the meaning of the invention, is attached to the positioning device 5 and is displaceable thereby in an axial displacement direction V provided by the axis A to generate the braking engagement on the brake disk 2, as indicated in FIG. 4 by the arrow. In the unoperated state of the braking device 1, an axial air gap L, which is schematically shown exaggeratedly wide in FIG. 4, is located between the brake disk 2 and the displaceable brake lining 32.

The structure of the positioning device 5 is shown in FIG. 4 and in the enlarged detail thereof in FIG. 6. The positioning device 5 comprises a first positioning drive 6, which has a ramp bearing, and a second positioning drive 7, which is axially coupled in series thereto, axially here with respect to the axis A, and which has a spindle drive. The first positioning drive 6, which is designed as a ramp bearing in the exemplary embodiment shown, comprises a drive-side curve disk 61 supported axially and in a rotationally-fixed manner on the brake actuator 4, and an output-side curve disk 62. Balls 63 are arranged between the curve disks 61 and 62. As can be seen in the schematic isolated view of FIG. 5, the curve disks 61 and 62 have ramp-like runways 64 which are axially opposite to one another and are located obliquely in relation to the axis A, between which balls 63 are rollable. A rotation of the output-side curve disk 62, upward in FIG. 5, relative to the fixed drive-side curve disk 61—as schematically indicated by the curved arrows-results in a linear displacement of the output-side curve disk 62 in the displacement direction V parallel to the axis A. The brake lining 32, as shown in FIG. 4, can thus be brought into braking engagement by operation of the first positioning drive 6.

The curve disk 62 is connected to a coaxial gear wheel 65, which is designed as a spur wheel and forms a drive wheel. The gear wheel 65 is in gear engagement with a first three-phase electric motor 41, which is designed here as an actuating motor, and in particular can be a permanent magnet synchronous motor. This first electric motor 41 enables the rotating drive of the curve disk 62 and thus an operation of the first positioning drive 6. The first electric motor 41 is operated via a circuit assembly, as is explained in more detail in particular hereinafter with reference to FIG. 7.

The second positioning drive 7, which is designed as a spindle drive in the example shown, has a threaded spindle 71 on the output side, which engages in the internal thread of a drive-side spindle nut 72. This internal thread is formed in the output-side curve disk 62 of the first positioning drive 6, so that the functions of the output-side curve disk 62 and the drive-side spindle nut 72 are advantageously unified in one structural element. The threaded spindle 71 is connected via a hub part 74 to a coaxial gear wheel 75, which is mounted rotatably in an axially fixed manner in the brake actuator 4. Via carriers 73, which in particular have radially protruding projections or teeth that engage in an axially displaceable manner in axial slots of the hub part 74, the threaded spindle is coupled in a torque-locked but axially-movable manner with the gear wheel 75. The gear wheel 75 can be embodied as a spur wheel like the gear wheel 65 and is coaxially arranged adjacent thereto. This gear wheel 75 is in gear engagement with a second three-phase electric motor 42, which is designed here as an actuating motor, and in particular can likewise be a permanent magnet synchronous motor. This second electric motor enables the rotating drive of the threaded spindle 71, and therefore an operation of the second positioning drive 7, wherein this second electric motor 42 is likewise operated via the above-mentioned circuit assembly, as is explained in more detail in particular hereinafter with reference to FIG. 7.

The threaded spindle 71 is axially connected via a thrust bearing 43, in particular an axial roller bearing as shown, to a pressure piece 44, on which the movable brake lining 32 is attached, as can be seen in FIG. 4. The pressure piece 44 can also be referred to as a piston.

The coupling device of the braking device 1 has a friction element 8, which is directed as a coaxial conical attachment from the curve disk 62 toward the second positioning drive 7. The conical attachment has a conical friction surface 81 arranged on the outside on an outer cone. The friction element 81 can preferably be formed integrally with the curve disk 62/spindle nut 72.

The friction element 8 is coupled in a friction-locked manner with a counter friction element 9 in the coupling engagement. The conical attachment plunges axially into a corresponding conical opening of the counter friction element 9 here, which has a conical friction surface 91 arranged in an inner cone. In the coupling engagement, the friction surface 81 and the counter friction surface 91 lie against one another in a friction-locked manner, as can be seen in FIG. 6. The counter friction element 9 is coupled in a torque-locked but axially movable manner with the gear wheel 75 via carriers 92, which engage in an axially displaceable manner in corresponding slots 76 in the hub part 74 or the gear wheel 75. A spring element 93 is arranged between the gear wheel 75 or the hub part 74 connected thereto and the counter friction element 9. The counter friction element 9 is elastically braced against the friction element 8 by its axially active spring force. A defined coupling torque of the friction clutch formed by the friction element 8 and the counter friction element 9 is thus generated.

To operate the braking device 1, the gear wheels 65 and 75 are rotated synchronously, so that the first positioning drive 6 executes a work stroke in the displacement direction V, so that the brake lining 32 passes the air gap L and comes into braking engagement with the brake disk 2. The synchronous drive of the gear wheels 65 and 75 can be effectuated by a synchronization of the drive speeds of the first electric motor 41 and the second electric motor 42, or by only one of the electric motors 41 or 42, while the respective other electric motor 42 or 41 runs along idly. The friction-locked coupling engagement between the friction element 8 and the counter friction element 9 then ensures a synchronous rotation of the gear wheels 65 and 75.

To adjust the width of the air gap L, the gear wheel 65 is fixed or blocked, in particular by a corresponding actuation of the first electric motor 41. The gear wheel 75 is rotated relative to the gear wheel 65 by the second electric motor 42, wherein the friction clutch slips through continuously in a sliding manner. Accordingly, the second positioning drive 7 is displaced uniformly, by which the width of the air gap L can also be continuously set and adjusted, for example to compensate for wear of the brake lining 32.

A particularly compact construction can be implemented in that the friction element 8 and the counter friction element 9 are entirely or at least partially arranged inside the gear wheels 65 and 75.

The braking devices 1 shown in FIG. 1 to FIG. 6 are designed as a floating caliper brake, also referred to as a sliding caliper brake. The brake lining 32 is pressed here by the pressure piece 44, and the brake lining 31 is pressed by the brake caliper 3 displaceable in relation to the brake disk 2 in the direction of the axis A against the brake disk 2. Alternatively, the proposed solution can also be used in a fixed caliper brake.

One advantageous circuit assembly 100 for operating the electric motors 41, 42 of the positioning device 5 and their architecture is shown as a block diagram in FIG. 7. The circuit assembly 100 in this exemplary embodiment comprises a first control path 101 having a first computing unit 107, a first driver stage 105, and a first power module 103 for controlling the first electric motor 41 and if needed for controlling the second electric motor 42. Furthermore, a first connection element 111 for connection to a voltage source of a motor vehicle, a first interface 113 for connection to a communication bus of a motor vehicle, and a third interface 115 for connection of a wheel speed sensor of a motor vehicle are assigned to the first control path 101. The first computing unit 107, which is designed in particular as a microcontroller circuit, the first driver circuit 105, and the first power module 103 are provided the energy required for operation via an EMI filter 121. The first computing unit 107 is designed to receive a plurality of data to determine an electric motor setpoint specification. The first computing unit 107 can thus receive rotor position signals from a rotor position sensor 109 assigned to the first electric motor 41. Moreover, the computing unit 107 is designed to receive a sensor signal of a wheel speed sensor as a further parameter via the third interface 115. The computing unit 107 can receive further vehicle parameters, such as a braking specification specified by a vehicle user or a driver assistance system or a current travel velocity of the motor vehicle, by means of a transceiver unit 124 via the first interface 113 via a communication bus of the motor vehicle, in particular a CAN bus, wherein data can also be transmitted via the transceiver unit 124 and the first interface 113 on the communication bus. The first computing unit 107 can receive further data from the first power module 103.

In this exemplary embodiment for the circuit assembly 100, the circuit assembly 100 comprises a second control path 102, which is essentially completely redundant to the first control path 101. This second control path 102 therefore comprises a second computing unit 108, a second driver stage 106, and a second power module 104 for controlling the second electric motor 42 and if needed for controlling the first electric motor 41. In addition, a second connection element 112 for connection to a voltage source of a motor vehicle, a second interface 114 for connection to a communication bus of a motor vehicle, and a fourth interface 116 for connection of a wheel speed sensor of a motor vehicle are assigned to the second control path 102. The second computing unit 108, which is in particular likewise designed as a microcontroller circuit, the second driver circuit 106, and the second power module 104 are provided the energy required for operation via an EMI filter 121. The second computing unit 108 is designed to receive a plurality of data to determine an electric motor setpoint specification. The second computing unit 108 can thus receive rotor position signals from a rotor position sensor 110 assigned to the second electric motor 42. Moreover, the second computing unit 108 is designed to receive a sensor signal of a wheel speed sensor as a further parameter via the fourth interface 116. The second computing unit 108 can receive further vehicle parameters, such as a braking specification specified by a vehicle user or a driver assistance system or a current travel velocity of the motor vehicle, by means of a transceiver unit 124 via the second interface 114 via a communication bus of the motor vehicle, in particular a CAN bus, wherein data can also be transmitted via the transceiver unit 124 and the second interface 114 on the communication bus. The second computing unit 108 can receive further data from the second power module 104.

In a normal operation, it is provided that the first computing unit 107 determines an electric motor setpoint specification for the first electric motor 41, and that the second computing unit 108 determines an electric motor setpoint specification for the second electric motor 42. The first computing unit 107 actuates the first power module 103 to influence the motor currents here via the first driver stage 105, so that the electric motor setpoint specification determined for the first electric motor 41 is implemented by the first electric motor 41. Accordingly, the second computing unit 108 actuates the second power module 104 via the second driver stage 106, so that the electric motor setpoint specification determined by the second computing unit 108 is implemented by the second electric motor 42.

In this exemplary embodiment, the first computing unit 107 and the second computing unit 108 are moreover connected to one another to exchange signals via a signal connection 130, so that signals can be exchanged between the first control path 101 and the second control path. In particular in the event of a detected functional disturbance with regard to one of the computing units, the control can be taken over solely by the still functional computing unit via this signal connection 130, wherein the functional computing unit provides the data and parameters necessary for determining the setpoint specification for the electric motor of the control path, the computing unit of which is functionally impaired, via the signal connection 130. However, as explained above, it is also possible for the implementation of a braking engagement to implement this by actuating only one electric motor.

According to a more cost-effective design variant, which is indicated only by means of the signal connection 131 here, the circuit assembly 100 may also comprise only a first computing unit 107. The second computing unit 108 would then be omitted. In this design variant, the necessary data and parameters are then transmitted directly to the first computing unit 107, then directly via a signal connection 131 via the second driver stage 106 to the second power module 104 and via the latter to the second electric motor 42.

According to a still more cost-effective design variant, which is likewise only indicated by means of a further signal connection 132 here, in addition to the second computing unit 108, the second driver stage 106 is also omitted, wherein the first computing unit 107 is designed in this case to actuate the second power module 104 and therefore the second electric motor 42 via the first driver stage 105.

Since the control paths 101, 102 of the circuit assembly 100 are designed redundantly and moreover a braking intervention can even be implemented using only one of the electric motors 41, 42, a particularly high level of fault tolerance is provided.

The exemplary embodiments which are shown in the figures and are explained in conjunction therewith serve to explain the invention and are not restrictive for it.

### LIST OF REFERENCE SIGNS

1 braking device
2 brake disk (counter brake part)
3 brake caliper
31, 32 brake lining (brake part)
4 brake actuator
41, 42 first, second electric motor
43 thrust bearing
44 pressure piece
5 positioning device
6 first positioning drive
61 curve disk
62 curve disk (integrated with spindle nut 72)
63 ball
64 runway
65 gear wheel (first drive wheel)
7 second positioning drive
71 threaded spindle
72 spindle nut (integrated with curve disk 62)
73 carrier
74 hub part
75 gear wheel (second drive wheel)
76 slot
8 friction element
81 friction surface
9 counter friction element
91 counter friction surface
92 carrier
93 spring element
100 circuit assembly
101 first control path
102 second control path
103 first power module
104 second power module
105 first driver stage
106 second driver stage
107 first computing unit
108 second computing unit
109 first rotor position sensor
110 second rotor position sensor
111 first connection element
112 second connection element
113 first interface
114 second interface
115 third interface
116 fourth interface
121 EMI filter
124 transceiver unit
130 communication connection between the computing units (107, 108)
131 connection between first computing unit (107) and second driver stage (106)
132 connection between first computing unit (107) and second power module (108)
A axis
R wheel axis
V displacement direction
L air gap

1-13. (canceled)

14. An electromechanical braking device for a motor vehicle, comprising:
a positioning device and a brake part connected thereto, which is displaceable by the positioning device along an axis and can be brought into braking engagement with a counter brake part;
wherein the positioning device has a first positioning drive and a second positioning drive and the positioning device, to implement a displacement movement, comprises a first three-phase electric motor and a second three-phase electric motor having a circuit assembly for operating the electric motors;
wherein the circuit assembly comprises a first control path having a first power module for controlling the first electric motor and a second control path having a second power module for controlling the second electric motor;
wherein the circuit assembly comprises a first computing unit and a first driver stage;
wherein the first computing unit is designed to determine an electric motor setpoint specification on the basis of acquired parameters and to actuate a power module to influence the motor currents via a driver stage, so that the electric motor setpoint specification is implemented.

15. The braking device as claimed in claim 14, wherein the second positioning drive is coupled in series with the first positioning drive, wherein the first positioning drive has a first drive wheel, which is drivable to rotate, and the second positioning drive has a second drive wheel, which is drivable to rotate and is coaxial to the first drive wheel, wherein a coupling device is arranged between the first drive wheel and the second drive wheel, and wherein the coupling device is designed as a friction clutch having a friction element, which is connectable in the coupling engagement in a friction-locked manner to a counter friction element, wherein the first electric motor enables an operation of the first positioning drive and the second electric motor enables an operation of the second positioning drive.

16. The braking device as claimed in claim 14, wherein the circuit assembly is designed to control the first electric motor and the second electric motor using the first computing unit and the first driver stage.

17. The braking device as claimed in claim 14, wherein the circuit assembly furthermore comprises a second driver stage, wherein the first driver stage is assigned to the first control path and the second driver stage is assigned to the second control path.

18. The braking device as claimed in claim 14, wherein the circuit assembly furthermore comprises a second driver stage and a second computing unit, wherein the first driver stage and the first computing unit are assigned to the first control path and the second driver stage and the second computing unit are assigned to the second control path.

19. The braking device as claimed in claim 18, wherein the first computing unit is designed to actuate the first power module to influence the motor currents of the first electric motor via the first driver stage and the second computing unit is designed to actuate the second power module to influence the motor currents of the second electric motor via the second driver stage.

20. The braking device as claimed in claim 19, wherein the first computing unit is designed to actuate the first power module to influence the motor currents of the first electric motor via the first driver stage and to actuate the second power module to influence the motor currents of the second electric motor via the second driver stage.

21. The braking device as claimed in claim 14, wherein a first rotor position sensor is assigned to the first electric motor and a second rotor position sensor is assigned to the second electric motor, which are each connected to the first computing unit and/or the second computing unit to transmit rotor position signals.

22. The braking device as claimed in claim 14, wherein the first control path comprises a first connection element for connection to a voltage source of a motor vehicle as an energy source and/or the second control path comprises a second connection element for connection to a voltage source of a motor vehicle as an energy source.

23. The braking device as claimed in claim 22, wherein the first connection element and/or the second connection element comprises an EMI filter.

24. The braking device as claimed in claim 14, wherein the first control path comprises a first interface for connection to a communication channel of a motor vehicle and/or the second control path comprises a second interface for connection to a communication channel of a motor vehicle.

25. The braking device as claimed in claim 14, wherein the first control path comprises a third interface for connection to a wheel speed sensor and/or the second control path comprises a fourth interface for connection to a wheel speed sensor.

26. The braking device as claimed in claim 14, wherein the first control path and/or the second control path comprises a transceiver unit.
